(19) United States
(12) Patent Application Publication
(10) Pub. No.: US 2019/0141176 A1
(43) Pub. Date: May 9, 2019

(54) METHOD FOR AIDING THE ISSUING OF AN INTERACTIVE COMMUNICATION REQUEST, SERVER, TERMINALS AND PROGRAMS FOR THE IMPLEMENTATION OF THE METHOD

(71) Applicant: Christophe BERNARD, Paris (FR)

(72) Inventor: Christophe BERNARD, Paris (FR)

(21) Appl. No.: 16/300,346

(22) PCT Filed: May 2, 2017
(86) PCT No.: PCT/FR2017/051047

§ 371 Date: Nov. 9, 2018

(30) Foreign Application Priority Data
May 10, 2016 (FR) 1654166

(51) Int. Cl. H04M 1/2745; H04M 3/42; H04M 1/725; H04M 3/436; H04M 3/493

(52) U.S. Cl. CPC H04M 1/274583; H04M 3/42365; H04M 2203/2072; H04M 3/436; H04M 3/4931; H04M 1/72566

(57) ABSTRACT

A server obtains indicators for a set of callable users who are in contacts of a calling user. The indicator for a callable user is a function of an information item dependent on the time on the availability of the callable user, and of a score allocated to the calling user by the callable user. The server transmits to a communication terminal at the disposal of the calling user, data to be processed for integration into an interface for issuing a communication request presentable on the terminal. The transmitted data are dependent on the indicators obtained for the set of callable users and allow the calling user to take note of which talker is most apt to respond to his request

The present invention relates to the facilitation of the emission of a request for interactive communication.

### BACKGROUND

Among the modes of network communication, which have been greatly developed over the last several decades in highly varied modes, two classes can be distinguished:
the interactive modes of communication, which suppose a simultaneous interaction between participants, such as telephone conversations, over a conventional switched network, wireless network in circuit mode or voice over IP, videotelephony, instant messaging (“chat”), etc.;
and the asynchronous modes of communication, such as short message service (SMS), email, websites, forums, blogs, social networks, etc.

While the asynchronous modes of communication have made considerable progress, the interactive modes of communication have in comparison not made much technical progress, even though their cost has been significantly reduced and they have been enriched by allowing the incorporation of static or animated images. The interactive modes of communication remain frustrating because often, attempts at interactive communication fail, even though the caller generally uses such a mode with the hope of quickly being connected to the called party.

The request for interactive communication may also bother the receiver thereof.

The failure of an attempt at interactive communication can be explained not only by the non-availability of the called party or the disturbance the attempt causes the called party, but also by a rejection of the call by the called party because of the identity of the caller, which is often presented at the same time as the call with the current communication means.

It has been proposed to present the caller with a connection status of each of the caller's or of a portion thereof, for example such as “busy”, “available”, “absent”, etc. Nevertheless, this availability information remains relatively rough. In particular, the caller still has a high uncertainty as to whether a contact with the status “available” will answer the request for interactive communication or will be bothered by the call.

In the application US 2013/0172051 A1, there is an attempt to predict the reachability of each person in a list of contacts by observing the activity of each person's mobile telephone on the basis of information from the accelerometer thereof or the more or less recent and/or frequent use thereof to communicate. Based on these predictions, priorities are established in the list of contacts, and a user is presented with the list ordered according to the priorities in order to facilitate the decision of the user to call or not call a certain person. Although this technique can improve the estimation of the availability of people in the list of contacts, it does not allow it to be predicted whether or not these people will decide to accept or not accept the demand for interactive communication.

Another technique, described in the U.S. Pat. No. 7,542,558 B2, aims to provide a caller with information on the mode of activity of a called party and the availability thereof to receive calls. The information to be provided to the caller can be configured by the called party. The latter can also choose a particular processing mode for a call according to various parameters including the identity of the caller, by configuring for example a particular ringtone, redirection of the call to a specific terminal, or a switch to voicemail. This technique also does not allow the caller to be informed a priori on whether the called party will decide to accept or not accept the request of the caller for interactive communication.

Given the risk of failure of a request for interactive communication, the person seeking to obtain an information often tends to use an asynchronous mode of communication, since it is easy to emit the same request in asynchronous mode to numerous parties and thus increase the chances of obtaining a response. The more the person is in a hurry to obtain the information, the more said person will contact parties in asynchronous mode, in order to increase the chances of a rapid response. Clearly, this type of behaviour increases the overall inconvenience caused to all of the parties involved. It also has the disadvantage of using communication networks excessively and inefficiently given the need, even though this need would be better met by using an interactive mode of communication, if it is possible to target the right person to call.

There is therefore a need to qualify in advance the chances that a request for interactive communication will not fail and will indeed be received, in order to reduce the frustration of seeking to communicate with a person who is unavailable or not liable to receive it, or that of being contacted by a person in an untimely manner.

### SUMMARY

A method is proposed for assisting the emission of a request for interactive communication, the method involving:

obtaining indicators for a set of callable users who are in the contacts of the calling user, the indicator for a callable user being a function of a time-dependent information on the availability of the callable user, and of a score attributed to the calling user by the callable user; and

transmitting, to a communication terminal available to the calling user, data to be processed for integration into an interface for emitting a request for communication presentable on the terminal, the data transmitted being dependent on the indicators obtained for the set of callable users.

The indicator for a callable user with respect to a calling user combines a subjective element, namely the score attributed to the calling user by the callable user, and a more objective element, substantially dependent on the time with respect to the business of the callable user. By presenting, to the caller, an interface for emitting a request for communication that takes into account these indicators for a set of callable users that are in the contacts of the caller, the method allows the latter to emit the request with a reasonable chance of success.

In one embodiment, obtaining the indicators for the set of callable users involves:

recording, in a server, the scores respectively attributed to the calling user by the callable users of the set,

collecting, in the server, the time-dependent availability information from the callable users of the set; and

determining the indicators in the server by combining the scores and the availability information.

Another possibility is that the callable users have terminals that themselves determine the indicators and provide them to the server when the availability information, or the scores, change. It is, however, preferable that the determination of the indicators is done by the server, which can then manage these indicators independently of the terminals that the callable users use to update the availability information or the scores.

It is noted here that the notion of server is not limited to configurations with a single machine. It can correspond to the entirety of the material and software platform used by the manager of the service allowing the facilitation of the emission of the requests for interactive communication.

In one embodiment of the method, the data transmitted to the communication terminal available to the calling user includes a list of callable users, ordered according to the indicators obtained. The calling user is then capable of realising which people are the most liable to answer the call. The list of callable users included in the data transmitted to the communication terminal available to the calling user, ordered or not, can mention the indicators respectively obtained for the callable users of the list.

Another aspect of the invention relates to a server, comprising at least one processor configured to execute the steps of a method as defined above. The configuration of the server is typically the result of a computer program, comprising instructions for implementing the method when it is executed on at least one processor of the server.

According to another aspect, a communication terminal is proposed, comprising:

a user interface for receiving, from a user of the terminal, scores respectively attributed to other users;

circuits for communication with a server; and

a processor configured to collect a time-dependent information on the availability of the user of the terminal, and to transmit, to the server, data on subjective availability with regard to the other users, the subjective-availability data including the scores attributed to the other users and the availability information collected or, for each other user, a combination of the attributed score with the availability information collected.

This terminal is a communication terminal available to a callable user in the method introduced above.

In one embodiment of this terminal, the processor is configured to receive the availability information of the user from the terminal via the user interface. Another possibility is that the availability information is deduced automatically, that is to say, without explicit action by the user, by an application executed by the processor of the terminal.

The user of the terminal can use it not only to provide the server with information on the contacts and the availability of the user, but also to formulate requests for interactive communication while taking advantage of the subjective-availability data that was provided by the contacts of the user. In this case, the processor of the terminal is configured to receive, from the server, data to be processed for integration in an interface for emission of a request for communication, the data received being dependent on indicators obtained by the server for a set of users callable by the user of the terminal, and it is further configured to control the user interface in order for it to present an interface for emitting a request for communication that integrates elements obtained by processing the received data.

In a specific embodiment of such a terminal, the processor is configured to obtain the elements integrated into the interface for emitting the request for communication while determining a priority for each callable user of the list by combining the indicator included in the data received from the server and the score attributed to said callable user by the user of the terminal. The user interface can thus be controlled by the processor in order for the emission interface presented to include at least one element for a callable user of the list having a maximal priority, allowing the selection thereof in order to emit the request for interactive communication.

Another aspect of the invention relates to a computer program for a communication terminal, the terminal comprising a user interface for receiving, from a user of the terminal, scores respectively attributed to other users, circuits for communication with a server, and a processor. The program comprises instructions that, when they are executed on the processor, configure said processor in order for the communication terminal to operate in the manner indicated above.

Yet another aspect of the invention relates to an interactive-communication system, comprising communication terminals and a server. Each communication terminal of this system comprises a user interface, circuits for communication with the server, and a processor configured to:

collect a time-dependent information on the availability of a user of the terminal; and

transmit the availability information collected to the server.

The processor of at least one of the communication terminals of the system, available to a first user, is further configured to:

receive, from the server, data to be processed for integration into an interface for emitting a request for communication, the data received being dependent on indicators obtained by the server for a set of second users callable by the first user who are in the contacts of the first user; and

control the user interface of the terminal in order for it to present an interface for emitting a request for communication that integrates elements obtained by processing the data received from the server.

The server of the system comprises circuits for communication with the terminals and a processor configured to:

record scores respectively attributed to the first calling user by the second users of the set;

receive the availability information transmitted from the communication terminals of the second users of the set;

obtain the indicators for each second user of the set according to the availability information of the second user and the score attributed to the first user by the second user.

### BRIEF DESCRIPTION OF THE DRAWINGS

Other particularities and advantages of the present invention will be clear in the following description of non-limiting examples of embodiments, in reference to the appended drawings, in which:

FIG. 1 illustrates an architecture of an interactive-communication system according to an embodiment of the invention;

FIG. 2 is a diagram illustrating an example of data processed in a system according to FIG. 1; and

FIG. 3 shows an example of an interface for emitting a request for communication that integrates elements determined in an embodiment of the invention.

### DESCRIPTION OF EMBODIMENTS

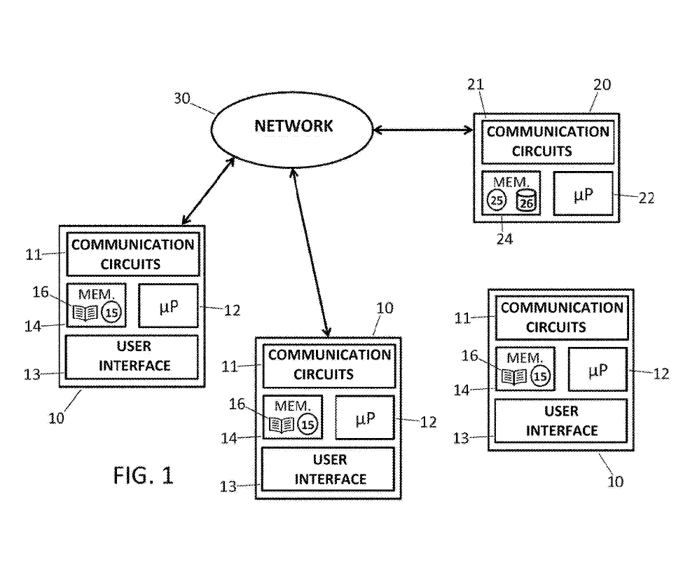

In reference to FIG. 1, an example of a system according to the invention comprises communication terminals 10 and a server 20 that are capable of communicating with each other via one or more networks 30. Typically, the network 30 comprises the Internet. However, this is not limiting. For example, it is possible to deploy such a system in an enterprise network.

The terminals 10 and the server 20 are provided with communication circuits 11, 21 that allow them to communicate with each other via the network 30. These circuits 11, 21 implement the communication protocols required for the exchanges over the network 30, including the lower-layer protocols suitable for the type of physical interface, wired or wireless, with which the terminals and the server are provided in order to be connected to the network 30 and, for example, the TCP/IP protocols by which the terminals 10 can communicate with the server 20 in the context of the service implemented by said server and described below. The communication circuits 11 of the terminals also allow them to communicate with each other via one or more interactive-communication modes such as telephony, voice over IP, videotelephony, chat, etc. Such communication circuits 11, 21 are routinely used in current communication systems.

Certain users can be temporarily disconnected from the network 30, like the one having the terminal 10 shown in the right-hand portion of FIG. 1, which is turned off, in flight mode or out of range of its access network.

The terminals 10 can be of various types: mobile telephones, connected tablets, personal computers provided with communication applications, etc. Each terminal 10 comprises one or more processors 12 that cooperate with the communication circuits 11, as well as a user interface 13. Various types of user interface can be used in the context of the present invention. The most common type at present is a touch screen allowing the user to both read the information intended for the user and input the data or commands of the user. Of course, it is also possible to use a keyboard separate from the screen, or an audio interface, touch interface, etc. It is also possible for the user interface 13 to combine various modes of interaction with the user.

Conventionally, the processor 12 of the terminal 10 functions with a memory 14 in which data and programs are recorded, including the interactive-communication applications available to the user of the terminal. The programs recorded in the memory 14 also include an application 15, the execution of which by the processor 12 allows the emission of requests for interactive communication by the user of the terminal to be facilitated.

The facilitation application 15 is written in a language suitable for execution in the environment of the operating system of the terminal 10. Another possibility is that it forms a set of functionalities integrated into the operating system itself. The memory 14 of the terminal 10 also contains a list of contacts 16 for the user of the terminal, at least some of the contacts being associated with respective indicators Gᵢⱼ described below. Alternatively, the list of contacts 16 for the user of the terminal 10 can be stored elsewhere than the terminal itself, while being accessible via the network 30, for example in the server 20.

The server 20, shown as a single machine in FIG. 1 but which can also be implemented in a decentralised manner via a plurality of machines connected to the network 30, also comprises one or more processors 22 that cooperate with a memory 24. The server application 25 cooperating with that of the terminals 10 to facilitate the emission of the requests for interactive communication from said terminals is recorded in the memory 24, and so is a user database 26 containing the information processed by the application 25 and useful to the applications 15 of the terminals.

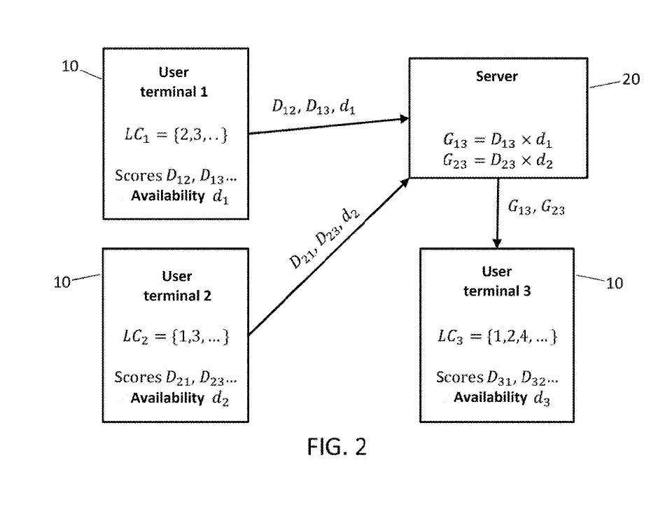

FIG. 2 shows a simplified example with users numbered i=1, 2, 3, . . . provided with terminals 10 capable of communicating with each other and with the server 20 via the network 30 (not shown). The list of contacts 16, or LCᵢ, of a user i includes, in this example, the other users 1, 2, . . . , i−1, i+1, i+2, . . . .

The user i attributes, to each of the users j of the list LCᵢ (j≠i), a score noted as Dᵢⱼ, which is indicative of the availability of the user i to receive incoming calls from the person j. In the example considered here, the facilitation application 15 of the terminal 10, executed on the processor 12, obtains scores Dᵢⱼ from the user i, via the user interface 13, and transmits these scores Dᵢⱼ to the server 20 via the communication circuits 11 (which is shown for the users 1 and 2 in FIG. 2). The score Dᵢⱼ can in particular be a modifiable input, among others, in the address book of the user i.

In particular, the scores Dᵢⱼ can be updated by the user i at the end of each communication session (like a call or a chat) in order to indicate whether said user wishes to have more or less communication with the same user j in the future.

The scores Dᵢⱼ can also incorporate indirect measures of the availability to answer, taking into account, for example, the number of calls made by the user i to the user j, or the time taken by the user i to answer the calls of the user j.

For example, the score Dᵢⱼ attributed by the user i to a user j can be expressed on a scale from 0 to 5 stars. The contacts that are not in the address book of the user i have, by default, a score of, for example, 0, which can be changed by the user i via the interface 13.

The application 15 executed in the terminal 10 further collects an information dᵢ on the general availability of the user i to receive requests for interactive communication.

The availability information dᵢ is dependent substantially on the time. It can be provided explicitly by the user i, via the interface 13. The user interface 13, of the graphic type, can for example have a ruler going from “Do not disturb” (dᵢ=0) to “Happy to receive calls” (dᵢ=5), along which the user i positions a cursor.

In order to determine the availability information, the application 15 executed on the terminal 10 of the user i can take into account, solely or in combination with an explicit indication from the user i, an observation of the interaction between the user i and the terminal 10. The application 15 can thus take into account the actual use of the terminal 10 (if it is already in interactive communication with another person, if the ringtone of the terminal is cut off, . . . ), as well as any indirect indication using learned models using the date, the time, the location of the terminal 10, or the calendar of the user i.

The application 15 executed on each terminal 10 communicates regularly, to the server 20, via the communication circuits 11, the scores Dᵢⱼ and the general availability information dᵢ, which is shown for the users i=1 and i=2 in FIG. 2. Another possibility is that the scores Dᵢⱼ are communicated to the server 20 only when the user i updates them, that is to say, in a relatively infrequent manner, and that the general availability information dᵢ is transmitted to the server 20 when this availability changes, or upon any reconnection of the terminal 10 to the server 20.

The application 25 executed on the processor 22 of the server 20 receives these elements {Dᵢⱼ, dᵢ} via its communication circuits 21 and uses them to determine specific availability indicators Gᵢⱼ of each user i with respect to each user j. The indicators Gᵢⱼ, as well as the elements {Dᵢⱼ, dᵢ}, are stored in the user database 26 recorded in the memory 24 of the server 20.

For example, the indicator Gᵢⱼ of a potentially called user i with respect to a potentially calling user j can be calculated by the processor 22 according to:

Gᵢⱼ=Dᵢⱼ×dᵢ (1)

It should be noted that these indicators Gᵢⱼ can also be calculated directly in the terminals 10 of the users i and transmitted to the server 20, with or without the elements {Dᵢⱼ, dᵢ}. In general, the server 20 obtains the indicators Gᵢⱼ that are dependent on the elements {Dᵢⱼ, dᵢ}. The obtaining can in particular be the result of a calculation carried out by the processor 22 of the server on the basis of the elements {Dᵢⱼ, dᵢ} received from the terminals as subjective-availability data, or of the direct reception of the indicators Gᵢⱼ from the terminals 10.

The indicators Gᵢⱼ are used to facilitate the emission of requests for interactive communication from the user j.

In the example shown in FIG. 2 with respect to the user j=3, the use involves, for the server 20, transmitting, to the terminal 10 of the user j, via the communication circuits 21, a list of callable users i and the associated indicators Gᵢⱼ. The list transmitted can cover all or a portion of the set of callable users i present in the list of contacts Lⱼ of the user j.

The application 15 executed by the processor 12 of the terminal 10 of the user j receives, from the server 20, via the communication circuits 11, the specific availability indicators Gᵢⱼ of the other users i of the list of contacts Lⱼ of the user with regard to the user. The application 15 is then capable of processing these indicators Gᵢⱼ in order to present, to the user j, an interface for emitting a request for communication that allows the user to realise which contacts are most liable to answer the request of the user.

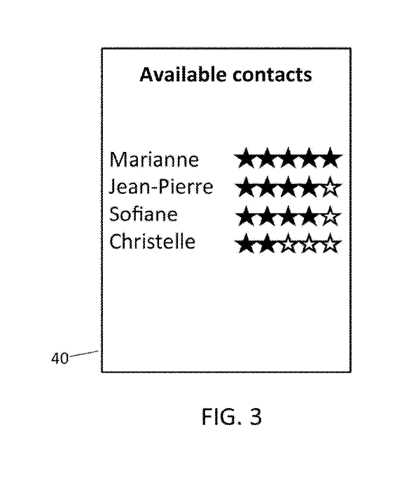

In particular, the application 15 can give priority to presenting, to the user j, the users i that are the most available, that is to say, for which the indicator Gᵢⱼ is the highest, in order to incite said user to give priority to calling those of the users i that are the most available. This can be carried out via an interface 40 that provides a description of the availability of the potential parties, like that of FIG. 3.

The interface for emitting a request for communication 40 of FIG. 3 is for example displayed by the application 15 in an area of a screen that is part of the user interface and allows the user j to select one of the callable users i out of the user's available contacts.

In one example of an embodiment, the grade Nᵢⱼ associated with each callable user i in the emission interface 40 is directly given by the indicator Gᵢⱼ, for example Nᵢⱼ=Gᵢⱼ/5 if Gᵢⱼ is given by (1) with 0≤Dᵢⱼ≤5 and 0≤dᵢ≤5. The grade Nᵢⱼ can also be a more complicated function of Gᵢⱼ. In the case of FIG. 3, the users i that are unavailable (Gᵢⱼ=0) are not displayed in the interface 40.

Moreover, rather than explicitly transmitting the indicators Gᵢⱼ, the server 20 can transmit, to the terminals 10, data derived from these indicators Gᵢⱼ, for example the grades Nᵢⱼ, allowing the calling user j to be informed in the interface 40.

It is also possible for the indicators Gᵢⱼ to not be transmitted by the server 20 to the terminal 10 of a calling user j, but for the server 20 to be limited to transmitting, to the terminal, an ordered list of callable users i sorted in decreasing order of the indicators Gᵢⱼ. In this case, the interface 40 presents an ordered list of contacts without the associated grades.

In another embodiment, the emission interface 40 does not include a list of callable users, but only the user i for whom the grade Nᵢⱼ is maximal, in order for the calling user j to be incited to call this user i for whom the probability of failure is the lowest. One way to do this is for the processor 12 of the terminal 10 to receive the indicators Gᵢⱼ for the various callable users i, and to select the one for whom the grade is maximal. Another way is for the server 20 to only transmit, to the terminal 10 of the user j, the indicator Gᵢⱼ having the greatest value, or giving the highest grade Nᵢⱼ.

Another interesting possibility involves the interface 40, for emitting requests for interactive communication and presented to a user j, comprising elements that take into account preferences specific to this user j. The interface 40 can thus place the callable users i who are most available and whom the user j also likes to contact in the foreground.

The measurements Sⱼᵢ used to present the most relevant contact choices thus represent combined availabilities, and are for example calculated according to:

Sⱼᵢ=Gᵢⱼ×Dⱼᵢ (2)

The calculation (2) can be carried out either by the processor 12 of the terminal 10 of the user j, or by the processor 22 of the server 20.

Alternatively or in addition, the interface can offer the user j to choose a most available contact from a given group (family, close friends, work group, clients, students in the same class, etc.).

The calculations (1) and (2) used to form the indicators Gᵢⱼ or the measurements Sⱼᵢ in the above examples use multiplications. Other combinations of the elements {Dᵢⱼ, dᵢ} can be used to calculate the indicators Gᵢⱼ. The same applies to the measurements Sⱼᵢ, which could be calculated for example according to:

Sⱼᵢ=min[Gᵢⱼ,Dⱼᵢ] (3)

In order to simplify the above description, it was supposed that each user only has a single terminal 10. It is nevertheless clear that the method is easily expanded to a configuration in which users can have a plurality of terminals (for example software on a desktop computer, web interface, mobile telephone, tablet, etc.). In such a situation, the configuration of the various software used by the user can be synchronised via communication of changes through the server 20, in order to use identical scores Dᵢⱼ on each terminal. It is possible, however, for the overall availability dᵢ of a user i to vary from one terminal to another, which is useful for example if the user uses a tablet but has turned off the user's telephone.

It is also possible for a user to divide the user's contacts into different groups and indicate a different overall availability for each group of users.

The embodiments described above are a simple illustration of the present invention. Various modifications can be made to said embodiments without going beyond the context of the invention that is given by the appended claims.

1-15. (canceled)

16. A method for assisting the emission of a request for interactive communication, the method comprising:
obtaining indicators for a set of callable users who are in contacts of a calling user, the indicator for a callable user being a function of a time-dependent information on the availability of the callable user, and of a score attributed to said calling user by said callable user; and
transmitting, to a communication terminal available to said calling user, data to be processed for integration into an interface for emitting a request for communication presentable on said terminal, said data transmitted being dependent on said indicators obtained for said set of callable users.

17. The method according to claim 16, wherein obtaining said indicators for said set of callable users involves:
recording, in a server, the scores respectively attributed to said calling user by the callable users of said set;
collecting, in said server, said time-dependent availability information from the callable users of said set; and
determining said indicators in said server by combining the scores and said availability information.

18. The method according to claim 16, wherein said data transmitted to said communication terminal available to said calling user includes a list of callable users, ordered according to said indicators obtained.

19. The method according to claim 16, wherein said data transmitted to said communication terminal available to said calling user includes a list of callable users and said indicators respectively obtained for the callable users of said list.

20. A communication terminal, comprising:
a user interface for receiving, from a user of the terminal, scores respectively attributed to other users;
circuits for communication with a server; and
a processor configured to collect a time-dependent information on the availability of said user of the terminal, and to transmit, to said server, data on subjective availability with regard to said other users, said data on subjective availability including said scores attributed to said other users and said availability information collected or, for each other user, a combination of the attributed score with said availability information collected.

21. The communication terminal according to claim 20, wherein the processor is configured to receive said availability information of said user from the terminal via said user interface.

22. The communication terminal according to claim 20, wherein the processor is configured to receive, from said server, data to be processed for integration into an interface for emitting a request for communication, said data received being dependent on indicators obtained by said server for a set of users callable by said user of the terminal, and wherein said processor is further configured to control said user interface in order for it to present an interface for emitting a request for communication that integrates elements obtained by processing said received data.

23. The communication terminal according to claim 22, wherein said data received from said server includes a list of callable users, ordered according to said obtained indicators.

24. The communication terminal according to claim 22, wherein said data received from said server includes a list of callable users and said indicators respectively obtained for the callable users of said list.

25. The communication terminal according to claim 24, wherein the processor is configured to obtain said elements integrated into said interface for emitting said request for communication while determining a priority for each callable user of said list by combining said indicator included in the data received from said server and said score attributed to said callable user by said user of the terminal.

26. The communication terminal according to claim 25, wherein the processor is configured to control said user interface in order for said emission interface presented to include at least one element for a callable user of said list having a maximal priority.

27. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 20.

28. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 20.

29. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 21.

30. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 22.

31. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 23.

32. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 24.

33. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 25.

34. A non-transitory computer-readable medium on which is stored a computer program for a communication terminal, the terminal comprising:
a user interface for receiving, from a user of the terminal, scores respectively attributed to other users;
circuits for communication with a server; and
a processor,
said program comprising instructions that, when they are executed on said processor, configure said processor in order for said communication terminal to be according to claim 26.
